(19) United States
(12) Patent Application Publication
(10) Pub. No.: US 2019/0135191 A1
(43) Pub. Date: May 9, 2019

(54) VIEWING DEVICE FOR VEHICLE

(71) Applicant: KABUSHIKI KAISHA TOKAI-RIKA-DENKI-SEISAKUSHO, Aichi (JP)

(72) Inventors: Naoki SUNAGAWA, Aichi (JP); Toshinari NAKAI, Aichi (JP); Tomonori ICHIKAWA, Aichi (JP); Masaki HAYASHI, Aichi (JP)

(21) Appl. No.: 16/301,138

(22) PCT Filed: May 12, 2017
(86) PCT No.: PCT/JP2017/018095

§ 371 Date: Nov. 13, 2018

(30) Foreign Application Priority Data
May 19, 2016 (JP) 2016-100671

(51) Int. Cl. B60R 11/02; B60R 11/04; B60R 1/12

(52) U.S. Cl. CPC B60R 11/02; B60R 11/04; B60R 1/12; B60R 2300/8093; B60R 2300/202; B60R 2300/306; B60R 2300/8026; B60R 2001/1253

(57) ABSTRACT

A partial image is cropped from a photographed image and is displayed on monitors as an image for viewing. When altering the viewing range by altering the cropping position of the partial image cropped from the photographed image, if the position of the partial image is altered as far as an end portion of the photographed image, which forms a limit to the movement of the cropping position, then a belt-shaped image (for example, a belt-shaped image formed by a red line or the like) is added to the image for viewing in the portion of the partial image that corresponds to the movement limit, and the resulting image for viewing is displayed.

### TECHNICAL FIELD

The present invention relates to a viewing device for a vehicle that photographs a vehicle peripheral area and displays the photographed images so as to enable the vehicle peripheral area to be viewed.

### BACKGROUND ART

Technology is known in which a viewing device for a vehicle that displays photographed images of a vehicle peripheral area is mounted in a vehicle instead of an optical mirror.

This type of viewing device for a vehicle provides visibility such as that provided by an optical mirror by displaying a partial image showing a portion of the range of a photographed image that is obtained by photography using a camera or the like. In this case, because a partial image is displayed, when altering the viewing range, this can be accomplished by altering the position where the partial image is cropped from the photographed image.

However, altering a viewing range generates problems such as how far a viewing range is offset from the original viewing range, and the difficulty of recognizing whether a viewing range is capable of being altered and the like.

For this reason, Japanese Unexamined Patent Application Laid-Open (JP-A) No. 2010-163104 describes technology in which a frame border showing a photographed image range, and a frame border showing a range of a cropped image are displayed as indicators together with the cropped partial image. By displaying these indicators, it is possible to easily recognize how far an altered viewing range is offset from the original viewing range, and to recognize via such indicators a viewing range that is capable of being altered.

### SUMMARY OF THE INVENTION

### Technical Problem

However, in JP-A No. 2010-163104, when altering a viewing range, although such indicators make it possible to roughly recognize which range of a photographed image is the cropping range, if the cropping range is moved to a movement limit such as an end portion or the like of a photographed image, then it is difficult to ascertain that the movement limit has been reached. In this case, it is not possible for the cropping range to continue to be moved in the same direction, and a user may not notice that a movement limit has been reached which may cause inconvenience and a sensation in the user that something is wrong. Consequently, there is room for improvement from this standpoint.

The present disclosure was conceived in view of the above-described circumstances, and it is an object thereof to eliminate any inconvenience when altering a viewing range that is caused by a user failing to notice a limit to movement of a partial image.

### Solution to the Problem

In order to achieve the aforementioned object, a first aspect of the present disclosure is provided with a display unit that displays an image for viewing that is used by a vehicle occupant to view a vehicle peripheral area, a control unit that controls the display unit such that the display unit displays a partial image that is cropped from a photographed image acquired by photographing the vehicle peripheral area as the image for viewing, and that, in response to an instruction given to alter a viewing range of the image for viewing, alters a cropping position of the partial image in accordance with the instruction and then displays the image for viewing, and a notification unit that, when the cropping position of the partial image has been altered by the control unit to a predetermined movement limit in the photographed image, gives notification that the movement limit has been reached.

According to the first aspect of the present disclosure, an image for viewing that is used by a vehicle occupant to view a vehicle peripheral area is displayed on the display unit, and the vehicle occupant is able to view the vehicle peripheral area by checking the displayed image for viewing.

In the control unit, a partial image cropped from a photographed image obtained by photographing a vehicle peripheral area is displayed as an image for viewing, and in response to an instruction given to alter the viewing range of the image for viewing, the display unit is controlled so as to alter the cropping position of the partial image in accordance with the instruction and then display the image for viewing. As a result, the image for viewing is displayed on the display unit, and in response to an instruction given to alter the viewing range, the viewing range can be altered in accordance with this instruction.

In addition, in the notification unit, when the cropping position of the partial image is altered by the control unit to a predetermined movement limit within the photographed image, notification is given that the movement limit has been reached. In other words, because notification is given regarding a movement limit of a partial image, it is possible to eliminate any inconvenience when altering a viewing range that is caused by a user not noticing a limit to movement of a partial image.

In accordance with a second aspect of the present disclosure, it is also possible for the notification unit to end the notification about the movement limit in at least one case out of a case in which a predetermined time has elapsed since the notification about the movement limit was given, and a case in which an instruction to end the alteration of the viewing range has been given. As a result, it is possible to prevent the notification about the movement limit from being unnecessarily continued.

In accordance with a third aspect of the present disclosure, it is also possible for there to be further provided an instruction unit that is used to give an instruction to alter the viewing range. As a result, it is no longer possible for a vehicle occupant to continue to instruct that an alteration be made to the cropping range using the instruction unit without noticing that the movement limit of the partial image has been reached.

In accordance with a fourth aspect of the present disclosure, it is also possible for the control unit to regard an establishment of predetermined conditions when the viewing range of an image for viewing is altered in conjunction with at least one of a turning of a vehicle or a reversing operation of a vehicle as being an instruction to alter an image for viewing. As a result, notification can be given when a cropping position of a partial image has reached the movement limit even during turn-related control in which the viewing range is altered in conjunction with a turn, and during reversing-related control in which the viewing range is altered in conjunction with a reversing operation.

In accordance with a fifth aspect of the present disclosure, it is also possible for the notification unit to give notification that a movement limit has been reached by displaying a notification image showing the movement limit has been reached in a portion of a partial image displayed on the display unit that corresponds to the movement limit. In other words, it is possible to give notification about a movement limit using a notification image.

In accordance with a sixth aspect of the present disclosure, it is also possible for the notification unit to display a notification image showing that a movement limit has been reached in a portion of a partial image that corresponds to the movement limit, and if the instruction is continued while this notification image is being displayed, for the display state of the notification image to be changed in accordance with the length of time that the instruction continues to be given. As a result, if a vehicle occupant fails to notice the movement limit, the attention of the vehicle occupant can be drawn to the movement limit by changing the display state of the notification image.

In accordance with a seventh aspect of the present disclosure, it is also possible for the notification unit to include a vibration generating unit that causes vibration to be generated in the instruction unit that is used to give an instruction to alter the viewing range, and by causing the instruction unit to be vibrated by the vibration generating unit, gives notification that the movement limit has been reached. It is thus possible to reliably provide notification about a movement limit by transmitting a vibration to a hand of a vehicle occupant who is operating the instruction unit.

### Advantageous Effects of the Invention

As has been described above, according to the present disclosure, the effect is attained that it is possible to eliminate any inconvenience when altering a viewing range that is caused by a user failing to notice a limit to movement of a partial image.

### BRIEF DESCRIPTION OF THE DRAWINGS

FIG. 1A is a view showing an example of a vehicle mounting position of a viewing device for a vehicle according to an exemplary embodiment of the present disclosure.

FIG. 1B is a view showing a schematic structure of a viewing device for a vehicle according to an exemplary embodiment of the present disclosure.

FIG. 2 is a block diagram showing a structure of a control system of a viewing device for a vehicle according to the present exemplary embodiment.

FIG. 3 is a view illustrating an image for viewing that is created by cropping a partial image from a photographed image.

FIG. 4 is a view illustrating an image for viewing when a viewing range is altered and a partial image reaches an end portion of a photographed image which is serving as a movement limit.

FIG. 5 is a view showing an example of a belt-shaped image which is serving as a notification image.

FIG. 6 is a view showing an example of a non-display area which is serving as a notification image.

FIG. 7 is a flowchart showing an example of a flow of processing which is performed by a control device of a viewing device for a vehicle according to the present exemplary embodiment.

FIG. 8A is a view showing an example in which a belt-shaped image which is serving as a notification image has been enlarged.

FIG. 8B is a view showing an example in which a non-display area which is serving as a notification image has been enlarged.

### DESCRIPTION OF THE EMBODIMENTS

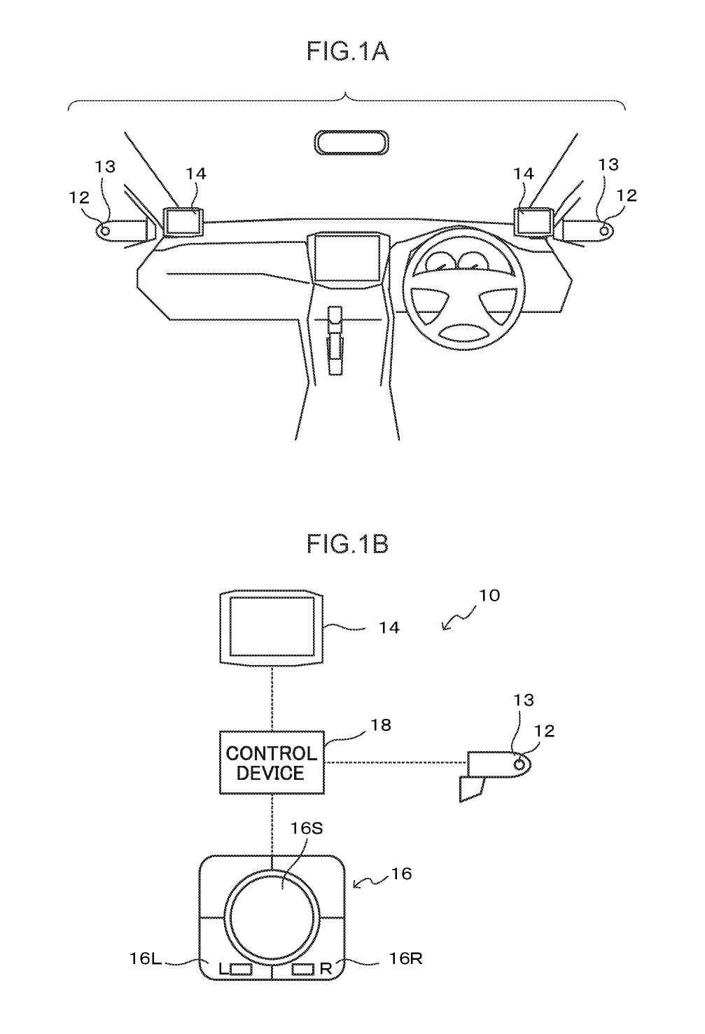

Hereinafter, an example of a preferred embodiment of the present disclosure will be described in detail with reference to the drawings. FIG. 1A is a view showing an example of a vehicle mounting position of a viewing device for a vehicle according to an exemplary embodiment of the present disclosure, while FIG. 1B is a view showing a schematic structure of a viewing device for a vehicle.

In a viewing device for a vehicle 10 according to the present exemplary embodiment, rear-side cameras 12, monitors 14 serving as display units, operating units 16 serving as instruction units, as well as control devices 18 serving as a control unit and a notification unit are provided respectively for both left and right sides of a vehicle.

The rear-side cameras 12 are disposed on an outer side of a vehicle front-side end in an intermediate portion in a vehicle up-down direction of a side door (i.e., a front-side door—not shown in the drawings) of a vehicle, and photograph a vehicle rear side. The rear-side cameras 12 are provided in a substantially rectangular parallelepiped-shaped casing body 13 which is serving as a supporting body, and a lens thereof is disposed so as to face towards the vehicle rearward side, and photograph this vehicle rearward side. An end portion on an inner side in the vehicle width direction of the housing body 13 is attached to the side door, and the housing body 13 is supported on the side door (i.e., on the vehicle body side) so as to be able to rotate in the vehicle front-rear direction. Note that it is also possible to employ a mode in which the casing body 13 is not mounted on a side door, but is instead mounted in another position such as on a front fender or the like.

The monitors 14 are provided adjacent to a lower end of a front pillar, and principally display photographed images from the rear-side cameras 12 as images for viewing. In other words, by using the monitors 14 instead of side mirrors, and checking the monitors 14, it is possible to view the vehicle rearward side as a vehicle peripheral area. Monitors 14 are provided respectively on both left and right sides of the vehicle.

The operating units 16 are used for instructing the display position of an image displayed on the monitors 14, namely, for instructing that a rearward side viewing range be altered. The operating units 16 are provided with switches and sensors that are used, for example, for instructing that the viewing range be altered in the vehicle width direction, or that the viewing range be altered in the vehicle up-down direction, and with switches and the like that are used for instructing the subject (i.e., the left or the right) monitor 14 to alter the viewing range. More specifically, the operating units 16 include a left switch 16L and a right switch 16R that are used to instruct a corresponding direction to the monitor 14 whose viewing range is being altered, and a direction instruction unit 16S that is used to instruct an altered direction.

Control devices 18 are provided respectively on both left and right sides of the vehicle, and control the display of photographed images from the respective left and right rear-side cameras 12. Note that the control devices 18 may also perform reversing-related control in order to make it easier to view low down obstacles on the sides of the vehicle by altering the viewing range on the vehicle rearward side during a reversing operation, and turn-related control in order to make it easier to view the vehicle rearward side by altering the viewing range in conjunction with an operation of a direction instructor.

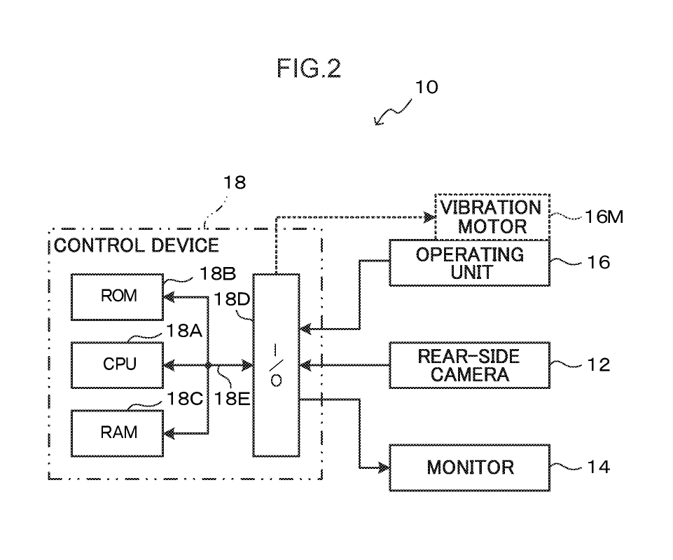

Next, the structure of a control system of the viewing device for a vehicle 10 according to the present exemplary embodiment will be described. FIG. 2 is a block diagram showing the structure of a control system of the viewing device for a vehicle 10 according to the present exemplary embodiment.

Each control device 18 is formed by a microcomputer in which a CPU 18A, ROM 18B, RAM 18C, and an I/O (input/output interface) 18D are connected respectively to a bus 18E.

Various types of program such as a viewing control program for a vehicle that is used to perform display control in order to display on the monitors 14 rear-side photographed images from the rear-side cameras 12, and the like are stored in the ROM 18B. Display control for the monitors 14 is performed as a result of the CPU 18A expanding the program stored in the ROM 18B in the RAM 18C and then executing this program.

The operating units 16 that are used to instruct that a viewing range be altered and the like, the rear-side cameras 12, and the monitors 14 are connected to the I/O 18D.

When an instruction or the like to alter the rear-side viewing range is made by a vehicle occupant, the operating unit 16 outputs an alteration instruction signal to the control device 18. More specifically, each operating unit 16 has the above-described left switch 16L, right switch 16R, and the direction instruction unit 16S shown in FIG. 1B. In other words, a corresponding (i.e., left or right) direction is instructed via the left switch 16L or the right switch 16R to the monitors 14 which alters the viewing range, and the altered direction (i.e., the vehicle width direction and the vehicle up-down direction) of the viewing range is instructed via the direction instruction unit 16S. Note that, as is shown by the dotted line in FIG. 2, it is also possible for the operating unit 16 to be provided with a vibration motor 16M serving as a vibration generating unit, and for the operating unit 16 to be made to vibrate by the vibration motor 16M so that notification about various type of information can be given to a vehicle occupant.

The rear-side camera 12 obtains rear-side photographed images by photographing the vehicle rearward side. Rear-side photographed images obtained via photography are output to the control device 18 as photographic results from the rear-side camera 12.

The monitors 14 display the rear-side photographed images photographed by the rear-side camera 12 in accordance with control performed by the control device 18.

Additionally, based on the photographic results from the rear-side cameras 12, the control device 18 performs display control for the monitors 14, and when an instruction to alter the rear-side viewing range has been made via the operating unit 16, the control device 18 performs control to alter the display position (i.e., the rear-side viewing range) of the monitors 14.

Note that display control of the left and right monitors 14 may be performed by a single control device 18, or, alternatively, a pair of control devices 18 may be provided corresponding to the left and right of the vehicle. If a pair of control devices 18 are provided corresponding to the left and right sides, then each control device 18 may be connected to the I/O 18D of the other control device 18 so that mutual intercommunication between the pair of control devices 18 is possible.

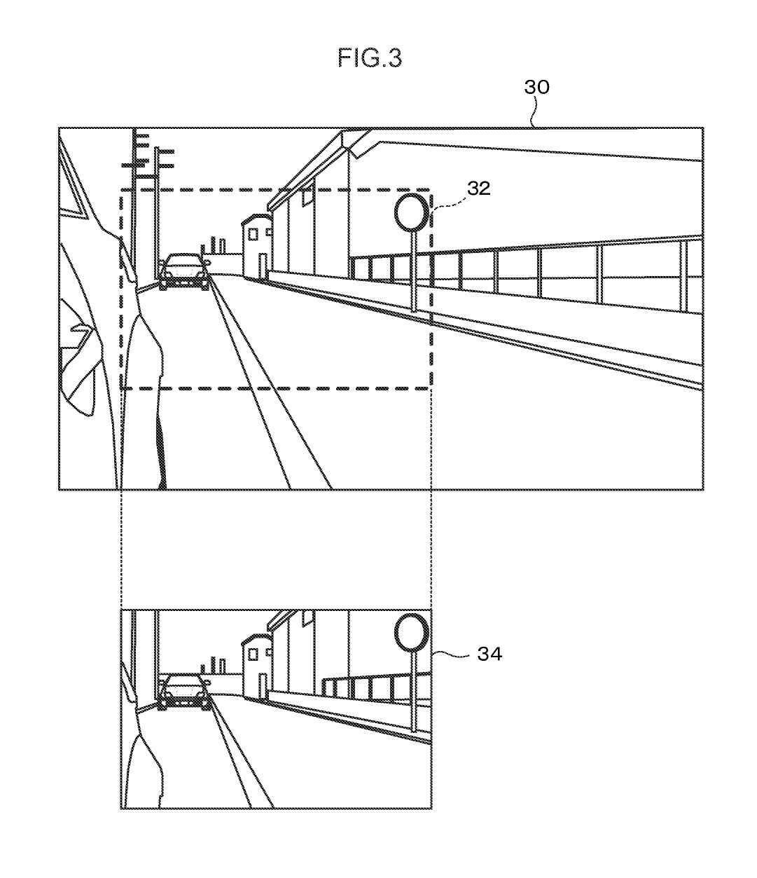

Here, a method of displaying photographed images from the rear-side cameras 12 on the monitors 14 by the control device 18 will be described in detail. FIG. 3 is a view illustrating an image for viewing created from a photographed image 30.

In the viewing device for a vehicle 10 according to the present exemplary embodiment, as is shown in FIG. 3, the rear side of the vehicle is photographed by a rear-side camera 12, and a partial image 32 shown by the dotted lines in FIG. 3 is cropped from the photographed image 30 obtained from this photography. The cropped partial image 32 is then displayed on the monitor 14 as an image for viewing 34. In other words, in the viewing device for a vehicle 10 according to the present exemplary embodiment, by altering the cropping position in order to display the partial image 32 of a portion of the range of the photographed image 30, it becomes possible to alter the viewing range. This alteration of the viewing range is performed by operating the operating unit 16. More specifically, the direction in which the viewing range is altered (i.e., to the left or right) is selected by operating the left switch 16L or the right switch 16R, and the direction in which the viewing range is altered (i.e., in the vehicle width direction and in the vehicle up-down direction) is instructed by operating the operating unit 16. As a consequence, the control device 18 alters the position of the cropping partial image 32 from the current position of the partial image 32 in the photographed image 30 in the direction instructed via an operation of the operating unit 16, and displays the result on the monitor 14. In other words, the image for viewing 34 displayed on the monitor 14 is displayed as moving sequentially in the direction instructed by the direction instruction unit 16S.

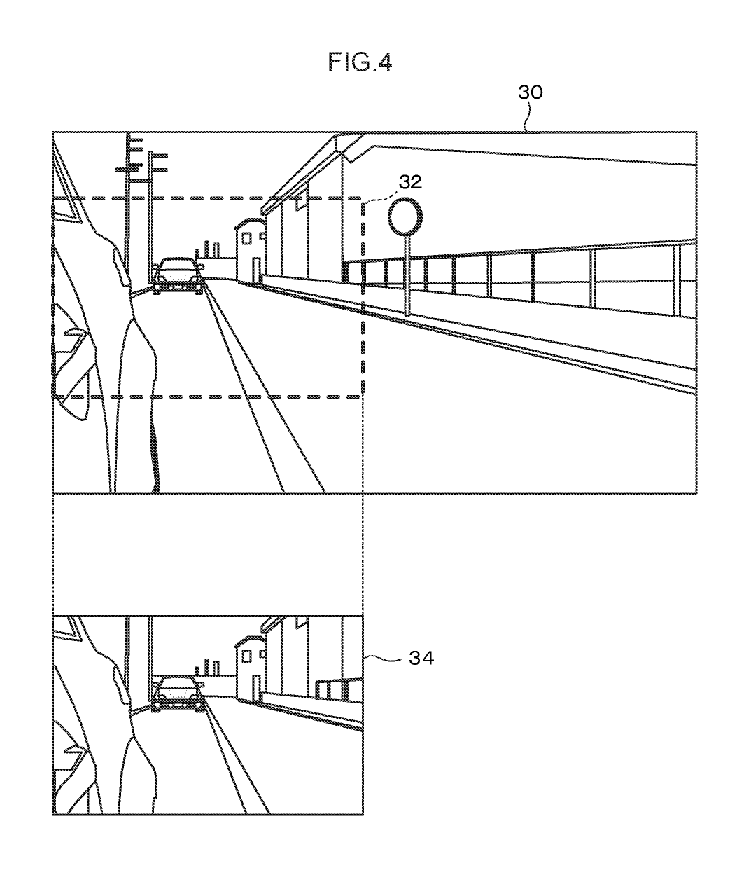

Here, as is shown in FIG. 4, when the cropping position of the partial image 32 reaches an end portion of the photographed image 30, the cropping position is unable to move any further in the same direction as the direction in which it was moving prior to arriving at the end portion of the photographed image 30, and movement of the image for viewing 34 is stopped. At this time, if the movement of the image for viewing 34 is simply stopped, it may be difficult for the vehicle occupant to notice that the partial image 32 has reached the end portion of the photographed image 30, and this may cause inconvenience to the vehicle occupant and a sense that something is not working properly.

Therefore, in the present exemplary embodiment, when altering the viewing range by altering the cropping position of the partial image 32, if the position of the partial image 32 is altered as far as a predetermined movement limit in the photographed image 30, then the vehicle occupant is notified that the movement limit has been reached.

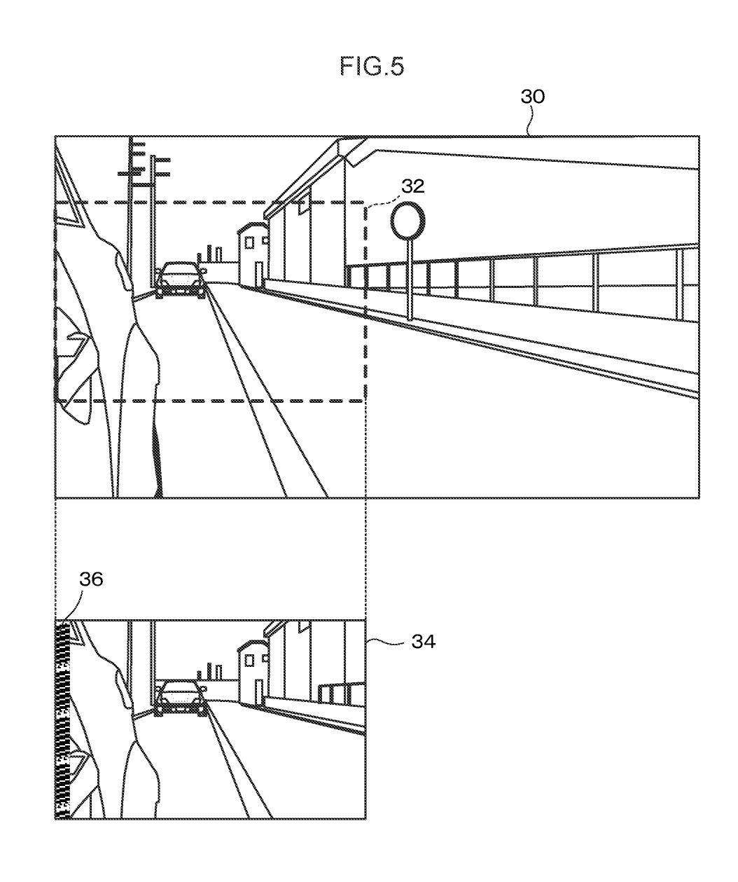

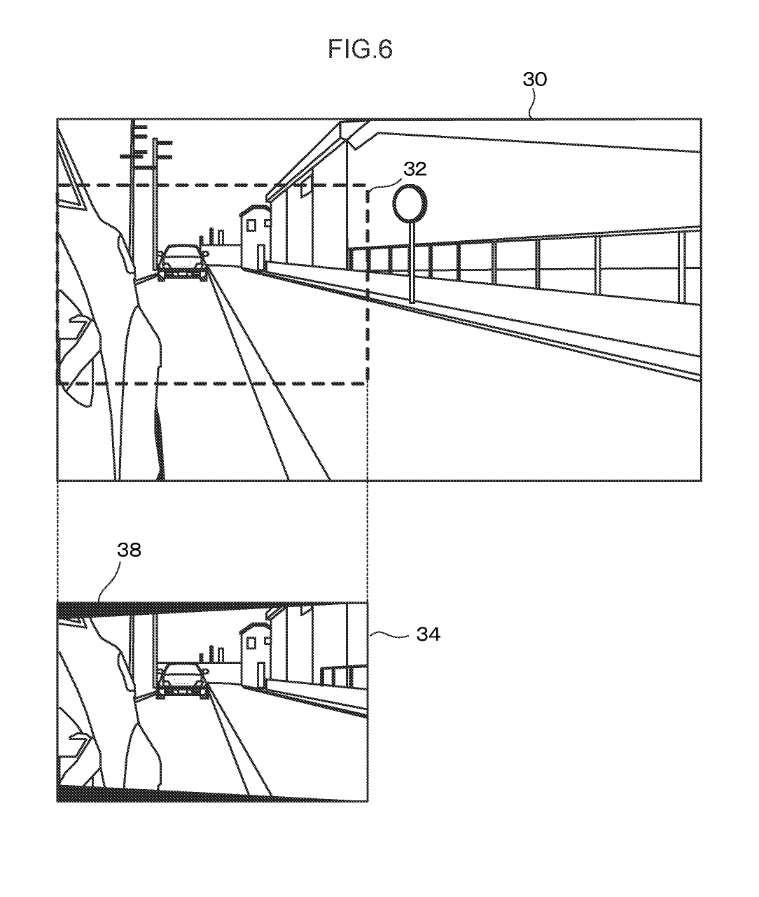

More specifically, in the present exemplary embodiment, as an example of a method of notifying that an end portion of the photographed image 30 is the movement limit, when the cropping position of the partial image 32 is altered, and an end portion of the partial image 32 reaches an end portion of the photographed image 30, a notification image showing that the movement limit has been reached is displayed. As is shown in FIG. 5, the notification image may be formed, for example, by displaying the image for viewing 34 in which a belt-shaped image 36 (for example, a belt-shaped image such as a red line or the like) is added to the portion of the partial image 32 that corresponds to the movement limit. Alternatively, as is shown in FIG. 6, a non-display area 38 may be provided in the direction that corresponds to the movement limit of the partial image 32. In FIG. 6, an example is shown in which the non-display area 38 is formed by making the display range of the image narrower on the side of the end portion that corresponds to the movement limit. The method used to make the display range narrower may be one in which the non-display area 38 is provided by making the display range narrower by using a masked image. Additionally, the non-display area 38 may be provided by making the display range narrower by compressing the image.

Note that because the image for viewing 34 undergoes mirror image conversion in order for the same image as that obtained from an optical mirror to be displayed on the monitors 14, the photographed images 30 shown in FIG. 3 through FIG. 6 are shown as images that have undergone mirror conversion in order to make the relationship between the partial image 32 in the photographed image 30 and the image for viewing 34 easier to understand.

The method used to notify a vehicle occupant that the movement limit of a partial image has been reached is not limited to the above-described display, and notification may also be provided via light or sound. Alternatively, notification may also be provided via a suitable combination of display, light, and sound.

Moreover, in the present exemplary embodiment, by ending the display of the notification image once a predetermined time has elapsed since the notification image was displayed, or if an instruction is given to end the alteration of the viewing range, the notification about the movement limit is prevented from being unnecessarily continued.

Moreover, the alteration of the viewing range is not limited to having to be instructed by the operating unit 16, and it is also possible, for example, for the alteration of the viewing range to be performed when predetermined conditions have been established for performing reversing-related control in which the viewing range is altered in conjunction with the above-described reversing operation, or for performing turn-related control in which the viewing range is altered in conjunction with a turn. During an alteration of the viewing range by a predetermined alteration amount in the reversing-related control or turn-related control, if the cropping position of the partial image is altered to the above-described movement limit, then it is also possible for the notification that the movement limit has been reached to be given via the display of a notification image or the like. Here, the predetermined conditions for performing reversing-related control or for performing turn-related control are, for example, conditions that are predetermined based on the direction instructor, the shift position, and the vehicle speed and the like, and known conditions can be used.

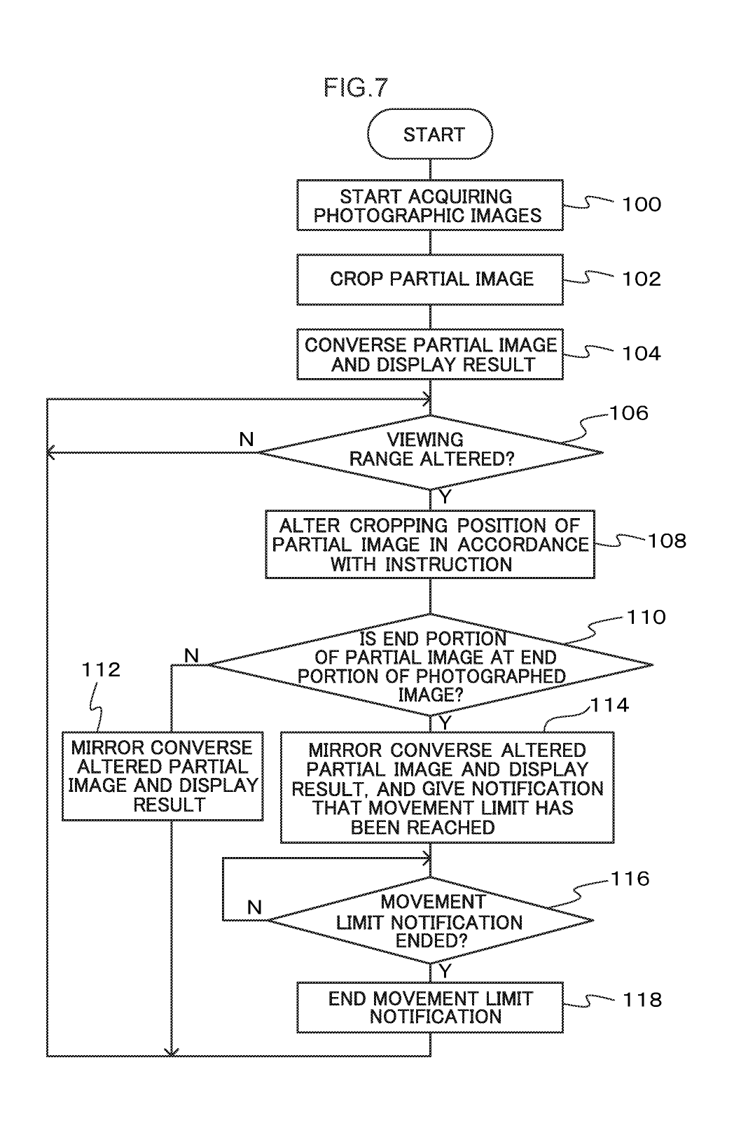

Next, specific processing performed by the control device 18 of the viewing device for a vehicle 10 according to the present exemplary embodiment which is formed in the above-described way will be described. FIG. 7 is a flowchart showing an example of a flow of processing performed by the control device 18 of the viewing device for a vehicle 10 according to the present exemplary embodiment. Note that the processing in FIG. 7 is described as commencing when an ignition switch (not shown in the drawings) is turned on, and ending when this ignition switch is turned off. Additionally, the processing in FIG. 7 is performed as a result of the CPU 18A expanding a viewing control program for a vehicle which is stored in the ROM 18B in the RAM 18C and then executing this program.

Firstly, in step 100, the CPU 18A starts acquiring photographed images captured by the rear-side cameras 12, and the routine then moves to step 102. In other words, photographic results from the rear-side cameras 12 are sequentially acquired.

In step 102, the CPU 18A crops the partial image 32 from the photographed image 30, and the routine moves to step 104. Note that the partial image at this time may be a partial image of a predetermined default position out of the photographed image, or may be a partial image of a previously instructed position prior to the ignition switch being turned off.

In step 104, the CPU 18A performs mirror conversion on the cropped partial image 32 and, as is shown in FIG. 3, displays the result on the monitors 14 as the image for viewing 34, and the routine moves to step 106. Note that, instead of performing mirror conversion on the partial image 32, it is also possible for the partial image to be cropped after mirror conversion has been performed on the photographed image 30.

In step 106, the CPU 18A determines whether or not there is an alteration to the viewing range. This determination may be made, for example, by determining whether or not the operating unit 16 has been operated and an alteration to the viewing range has been instructed, and by waiting until this determination is affirmative, in which case the routine moves to step 108. Note that, instead of determining whether or not an alteration to the viewing range has been instructed via the operating unit 16, it is also possible to determine whether or not predetermined conditions for performing reversing-related control or for performing turn-related control have been established. Alternatively, it is also possible to determine whether or not at least one of an instruction to alter the viewing range made via the operating unit 16, or an instruction to alter the viewing range on the basis that predetermined conditions for performing related control (i.e., at least one of reversing-related control or turn-related control) have been established has been given.

In step 108, the CPU 18A alters the cropping position of the partial image 32 in accordance with the instruction, and controls the monitors 14 such that the image for viewing 34 is displayed, and the routine then moves to step 110.

In step 110, the CPU 18A determines whether or not an end portion of the partial image 21 has reached an end portion of the photographed image 30 which is serving as the movement limit. If this determination is negative, the routine moves to step 112, while if the determination is affirmative, the routine moves to step 114.

In step 112, the CPU 18A performs mirror conversion on the partial image 32 which has been altered in accordance with the instruction, and controls the monitors 14 such that the image for viewing 34 is displayed thereon, and the routine then moves to step 106 where the above-described processing is repeated.

In contrast, in step 114, the CPU 18A performs mirror conversion on the partial image 32 which has been altered in accordance with the instruction, and controls the monitors 14 such that the image for viewing 34 is displayed thereon, and also gives notification about the movement limit, and the routine then moves to step 116. In other words, notification about the movement limit can be given by displaying a notification image. As a result of this, when the viewing range is altered via an operation of the operating unit 16, there is no longer any possibility of a vehicle occupant continuing an operation because they have not noticed the movement limit of the partial image 32. Note that, in the present exemplary embodiment, as is described above, the method used to give notification about the movement limit is one in which the image for viewing includes a notification image which has been added to the partial image 32, however, it is also possible for light and sound to be used in combination with this notification image.

In step 116, the CPU 18A determines whether or not to end the notification about the movement limit. This determination is made by determining at least one of whether or not a predetermined time has elapsed since the notification image was displayed, or whether or not an instruction has been given to end the alteration of the viewing range, and the CPU 18A waits until this determination is affirmative, at which point the routine moves to step 118.

In step 118, the CPU 18A ends the notification about the movement limit and the routine returns to step 106 where the above-described processing is repeated.

By performing the above-described processing, if the viewing range of the image for viewing 34 displayed on the monitors 14 is to be altered, the position of the partial image 32 that is to be cropped is altered, and if the position of the partial image 32 that is to be cropped reaches the end portion of the photographed image which forms the movement limit, then notification is given that this position is the movement limit. As a result, it is possible to eliminate any inconvenience when altering a viewing range that is caused by a vehicle occupant failing to notice the movement limit of the partial image.

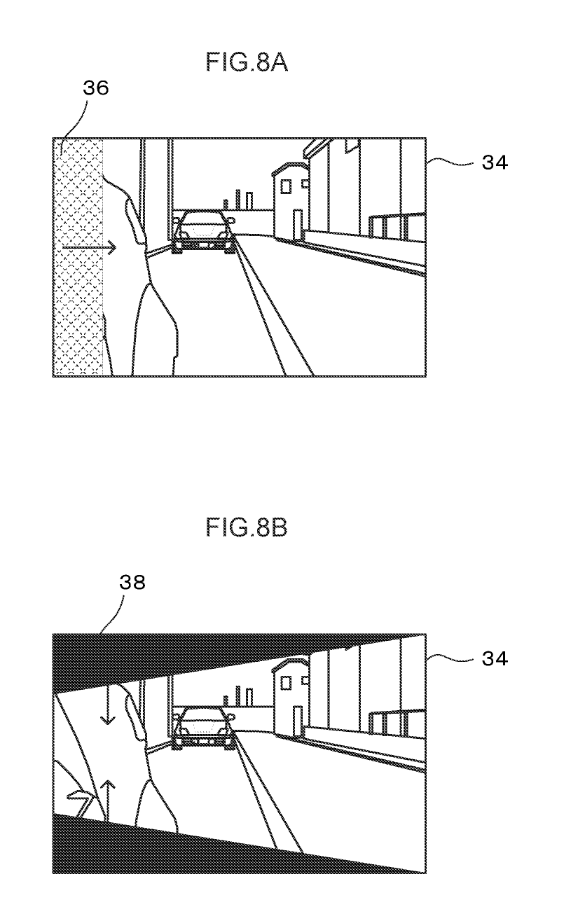

Note that, in the present exemplary embodiment, when the viewing range is altered and a notification image is displayed as a result of the operating unit 16 being operated, if the instruction to alter the viewing range continues to be given via the operating unit 16 while the notification image is being displayed, then it is also possible to change the display state of the notification image. Examples of a method used to change the display state include at least one of enlarging the area occupied by the notification image, causing this area to flash on and off, and changing the color thereof. If the display area of the notification image is enlarged, then the area where the notification image is displayed can be gradually enlarged as the time for which the instruction to alter the viewing range via the operating unit 16 continues grows progressively longer. As an example of an increase in the area where the notification image is displayed, as is shown in FIG. 8A, the display area of the belt-shaped image 36 which is serving as a notification image may be enlarged in the direction shown by the arrow. Moreover, as is shown in FIG. 8B, it is also possible to enlarge the non-display area 38 which is serving as a notification image in the directions shown by the arrows. By employing this method, if a vehicle occupant fails to notice the movement limit, the attention of the vehicle occupant can be drawn to the movement limit by enlarging the area of the notification image. Examples of changing the display state of the notification image are not limited to enlargements, and it is also possible to simultaneously change the display state by flashing the notification image on and off (such as by making this flashing become gradually quicker as the time for which the alteration instruction continues grows progressively longer), or by changing the color thereof or the like in accordance with the time for which the instruction to alter the viewing range via the operating unit 16 continues. Additionally, in the same way, if the predetermined conditions for the turn-related control or the reverse movement-related control having been established is regarded as an instruction to alter the viewing range, if the instruction continues while the notification image is being displayed, then as the time for which the instruction continues grows progressively longer, the area where the notification image is displayed can be gradually enlarged.

Moreover, in the above-described exemplary embodiment, examples in which notification about the movement limit of a partial image is given via a display, and in which sound and light and the like may also be used as the notification method are described, however, the notification method is not limited to these examples. For example it is also possible to provide the vibration motor 16M or the like in the operating unit 16, and to give notification by generating a vibration in the operating unit 16. More specifically, the vibration motor 16M may be provided in the direction instruction unit 16S in the manner shown by the dotted line in FIG. 2, and when the cropping position of a partial image reaches an end portion of the photographed image which is serving as the movement limit, notification that the movement limit has been reached may be given by causing the direction instruction unit 16S to vibrate by operating the vibration motor 16M. By employing this method, it is possible to reliably notify a vehicle occupant that the movement limit has been reached by transmitting a vibration to the hand of the vehicle occupant who is operating the operating unit 16. Furthermore, by using a suitable combination of vibration using the vibration motor 16M, a notification image, light, and sound to provide notification that the movement limit has been reached, it is possible to provide even more reliable notification that a movement limit has been reached.

Moreover, in the above-described exemplary embodiment, an end portion of the partial image 32 reaching an end portion of the photographed image 30 is described as an example of a movement limit when altering the cropping position of the partial image 32, however, the present disclosure is not limited to this. For example, the movement limit may also be several pixels before the cropping position of the partial image 32 reaches the end portion of the photographed image 30.

Moreover, in the above-described exemplary embodiment, a viewing device for a vehicle that photographs and views a vehicle rearward side as the vehicle peripheral area is described as an example, however, the present disclosure is not limited to this. For example, the present disclosure may also be applied to a viewing device for a vehicle that photographs and views other directions such as a vehicle outer side, a vehicle forward side, and a vehicle rear.

In addition, the processing performed by the control device 18 in the above-described exemplary embodiment is described as software processing, however, the present disclosure is not limited to this. For example, the processing performed by the control device 18 may also be performed by hardware, or by a combination of both hardware and software.

Moreover, the processing performed by the control device 18 in the above-described exemplary embodiment may also be stored as a program on storage media, and these storage media may then be distributed.

Furthermore, the present disclosure is not limited to the above description, and it should be understood that various modifications and the like may be made thereto insofar as they do not depart from the spirit or scope of the present disclosure.

Priority is claimed on Japanese Patent Application No. 2016-100671, filed May 19, 2016, the disclosure of which is incorporated herein by reference.

1.-7. (canceled)

8. A viewing device for a vehicle, comprising:
a display unit that displays an image for viewing that is used by a vehicle occupant to view a vehicle peripheral area;
a control unit that controls the display unit such that the display unit displays a partial image that is cropped from a photographed image acquired by photographing the vehicle peripheral area as the image for viewing, and that, in response to an instruction given to alter a viewing range of the image for viewing, alters a cropping position of the partial image in accordance with the instruction and then displays the image for viewing; and
a notification unit that, when the cropping position of the partial image has been altered by the control unit to a predetermined movement limit in the photographed image, gives notification that the movement limit has been reached by displaying in the partial image a notification image showing that the movement limit has been reached.

9. The viewing device for a vehicle according to claim 8, wherein the notification unit gives notification that the movement limit has been reached by displaying a notification image showing that the movement limit has been reached in a portion of the partial image being displayed on the display unit that corresponds to the movement limit.

10. The viewing device for a vehicle according to claim 8, wherein the notification unit gives notification that the movement limit has been reached by displaying a notification image showing that the movement limit has been reached in a direction that corresponds to the movement limit in the partial image being displayed on the display unit.

11. The viewing device for a vehicle according to claim 8, wherein the notification unit ends the notification about the movement limit in at least one of a case in which a predetermined time has elapsed since the notification about the movement limit was given, or a case in which an instruction to end the alteration of the viewing range has been given.

12. The viewing device for a vehicle according to claim 8, further comprising an instruction unit that is used to give an instruction to alter the viewing range.

13. The viewing device for a vehicle according to claim 8, wherein the control unit regards an establishment of predetermined conditions when the viewing range of an image for viewing is altered in conjunction with at least one of a turning of a vehicle or a reversing operation of a vehicle as being an instruction to alter an image for viewing.

14. The viewing device for a vehicle according to claim 8, wherein the notification unit displays a notification image showing that a movement limit has been reached in a portion of a partial image that corresponds to the movement limit, and if the instruction is continued while this notification image is being displayed, changes the display state of the notification image in accordance with the length of time that the instruction continues to be given.

15. The viewing device for a vehicle according to claim 8, wherein the notification unit includes a vibration generating unit that causes vibration to be generated in the instruction unit that is used to give an instruction to alter the viewing range, and by causing the instruction unit to be vibrated by the vibration generating unit, gives notification that the movement limit has been reached.
